(19) United States
(12) Patent Application Publication
(10) Pub. No.: US 2005/0086209 A1
(43) Pub. Date: Apr. 21, 2005

(54) Conceptual article collector

(76) Inventor: Peilin Chou, Taipei (TW)

Correspondence Address: Pavel Pogodin, 617 North Delaware Street, San Mateo, CA, 94401, US

(21) Appl. No.: 10/688,295

(22) Filed: Oct. 16, 2003

(51) Int. Cl. G06F 7/00

(52) U.S. Cl. 707/3

(57) ABSTRACT

Conceptual article collector comprising a concept-character string look-up-table indexed by keywords for searching purpose, each keyword corresponding to a plurality of character strings and their respective searching conditions; a character string-article look-up-table indexed by character strings contained in said concept-character string look-up-table, each character string corresponding to a quantity of articles being processed; an article pre-search means to from time to time search a quantity of articles based on character strings in said concept-character string look-up-table and to store result of such search in said character string-article look-up-table; an article search means to search corresponding character strings in said concept-character string look-up-table according to keywords input by user, to search corresponding articles of the searched character string in said character string-article look-up-table, to calculate the relative intensity values of each searched article and the concept represented by said input keyword and to output result of such calculation; and an article database to store a quantity of articles to be searched.

### FIELD OF THE INVENTION

The present invention pertains to a conceptual article collector, especially to an article searching tool that analyzes property of articles.

### BACKGROUND OF THE INVENTION

Using an article searching tool to collect useful articles in a database containing a large quantity of articles, especially in the internet, has become popular to everyone 11 one's daily life. The most popular article searching tool in the so-called “whole-text search engine”. The search engine searches articles within a designated area after the user has input one or more “keywords” and related Boolean operation formula(s) including operands such as AND, OR, NAND etc. The search engine compares the identical or similar parts of strings contained in an article with keywords as input to calculate the Boolean value according to the input formulas and identifies articles which Boolean value appears to be “1” after 5 such calculation.

Although the whole text search engine is able to identify or screen articles form a large quantity of article, result of such search is always still a quantity of article. The “conceptual article collector” thus serves to improve the correctness of searching of articles. A conceptual article collector interprets the input keywords (“searching keywords”) into search conditions comprising a group of keyword strings and descriptive intensity values (“relation values”) of respective keyword strings relating to concepts represented by the searching keywords and analyzes the character of articles according to these search conditions to decide the relative intensity values of respective articles in relation to the concept represented by the search keywords. If after calculation the relative intensity value of an article is greater than a threshold, the article will be decided very relative or closely relative to the search keywords.

The conceptual article collector is very helpful to users who needs to search or collect articles from a large quantity of article from time to time. However, the calculation process for a conceptual article collector is complicated and is conducted to the whole text of all article belonging to the area of interests one by one. As a result, in searching or collecting articles of a quantity, a great deal of time will be needed.

Real-time collection of articles in a large database or in the internet is not possible.

Generally speaking, it takes about 1,000 minutes to give the result of searching in a database containing 500,000 articles, if an ordinary personal computer is used to search in the internet, while factors such as operational speed of hardware, work schedule, bandwidth etc. give minor influence to the searching time.

Taiwan patent No. 146100 relates to a conceptual article collector, in which a look-up-table is provided to define the relations between searching keywords and their respectively corresponding character strings. While searching, numbers of location of the character strings existing in an article are summed to represent the relative intensity value of the article in relating to the searching keywords. Articles with relative intensity values greater than a threshold are identified.

It is necessary to provide a novel conceptual article collector which analyzes character of a large quantity of articles within a relatively short time.

It is also necessary to provide a conceptual article collector that automatically conduct collection of articles when the user is off-line.

### OBJECTIVES OF THE INVENTION

The objective of the invention is to provide a novel conceptual article collector which analyzes character of a large quantity of articles within a relatively short time.

Another objective of the invention is to provide a conceptual article collector that automatically conduct collection of articles when the user is off-line.

### SUMMARY OF THE INVENTION

According to the present invention, a novel conceptual article collector is provided. The conceptual article collector of this invention comprises: a concept-character string look-up-table indexed by keywords for searching purpose, each keyword corresponding to a plurality of character strings and their respective searching conditions; a character string-article look-up-table indexed by character strings contained in said concept-character string look-up-table, each character string corresponding to a quantity of articles being processed; an article pre-search means to from time to time search a quantity of articles based on character strings in said concept-character string look-up-table and to store result of such search in said character string-article look-up-table; an article search means to search corresponding character strings in said concept-character string look-up-table according to keywords input by user, to search corresponding articles of the searched character string in said character string-article look-up-table, to calculate the relative intensity values of each searched article and the concept represented by said input keyword and to output result of such calculation; and an article database to store a quantity of articles to be searched.

The above and other objectives and advantages of this invention will be clearly understood from the detailed description by referring to the following drawings.

### BRIEF DESCRIPTION OF THE DRAWINGS

FIG. 1 shows the systematic diagram of the conceptual article collector of this invention.

FIG. 2 is a table shows several popular search keywords and a number of their respectively corresponding character strings and their weights.

FIG. 3 illustrates the flowchart of search conducted by the article search means of the present invention

### DETAILED DESCRIPTION OF THE INVENTION

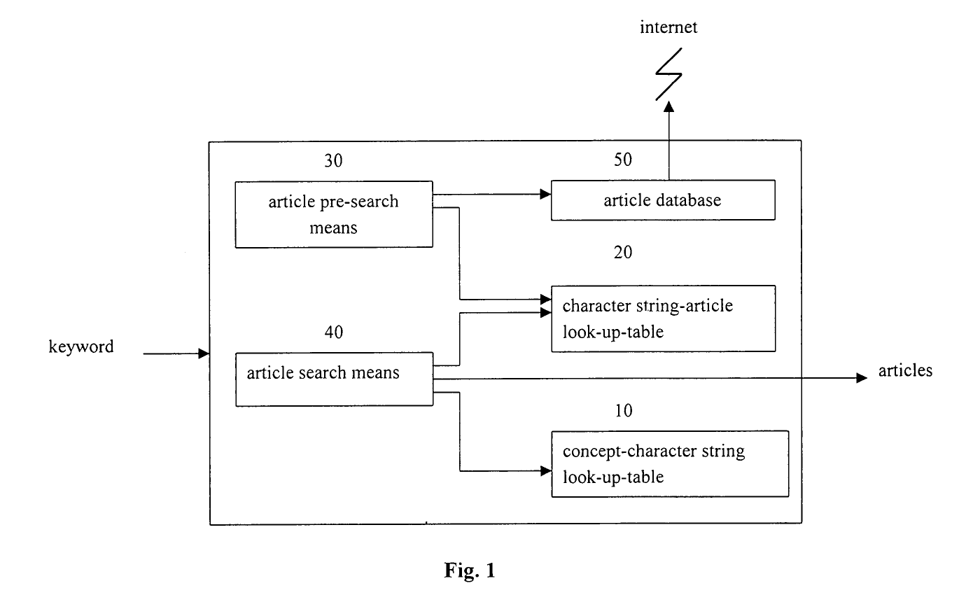

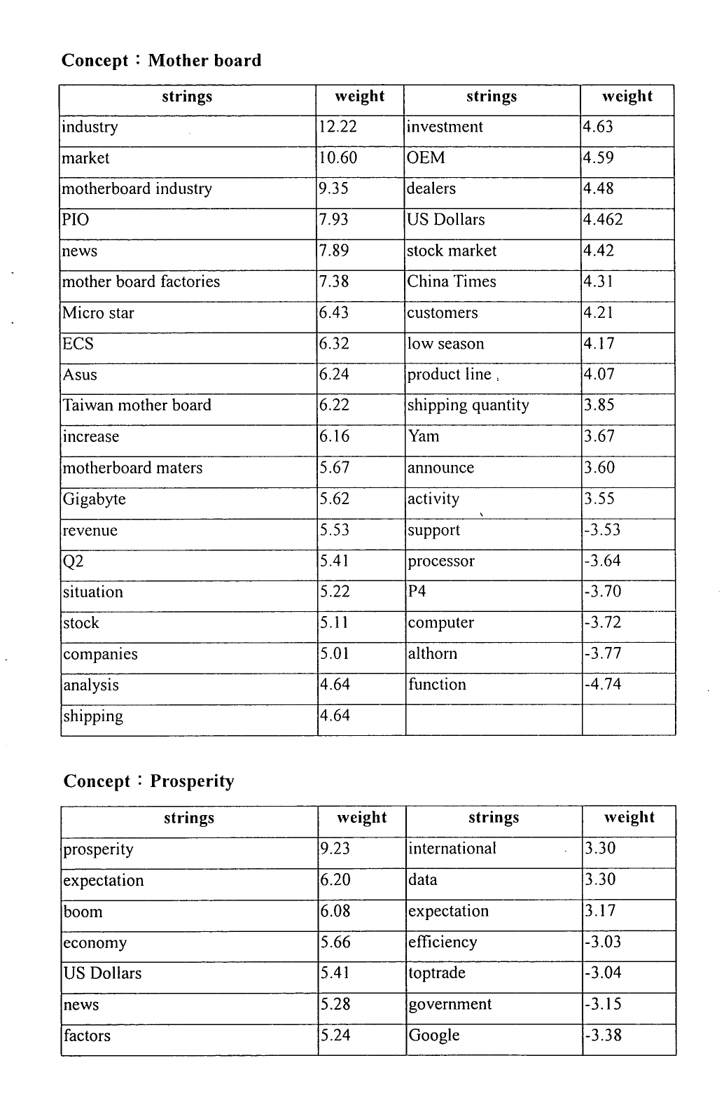

FIG. 1 shows the systematic diagram of the conceptual article collector of this invention. As shown in this invention, the conceptual article collector comprises: a concept-character string look-up-table 10 indexed by keywords for searching purpose, each keyword corresponding to a plurality of character strings and their respective searching conditions; a character string-article look-up-table 20 indexed by character strings contained in said concept-character string look-up-table 10, each character string corresponding to representative codes of a quantity of articles being processed; an article pre-search means 30 to from time to time search a quantity of articles based on character strings in said concept-character string look-up-table 10 and to store result of such search in said character string-article look-up-table 20; an article search means 40 to search corresponding character strings in said concept-character string look-up-table 10 according to keywords input by user, to search corresponding articles of the searched character string in said character string-article look-up-table 20, to calculate the relative intensity values of each searched article and the concept represented by said input keyword and to output result of such calculation; and an article database 50 to store a quantity of articles to be searched.

In the above modules, the concept-character string look-up-table 10 includes a plurality of popular keywords that are used to search articles by ordinary or professional users (“search keywords”), and their respectively corresponding character strings that frequently exist in articles that are closely relative to the concept or concepts represented by the search keywords. For example, for a search keyword (Concept 1), m character strings that frequently exist in a predetermined number (n) of article (Documents 1-n), after a research conducted to a group of limited samples of article, are listed as “corresponding character strings” of Concept 1. Here, the term “character string” may pertain to “word” under the definition of the natural language. Notable is that a “character string” suited in this invention is not necessarily a “word”. Any combination of a certain number of adjacent characters or symbols may be used as a “character string” in this invention. A single “character” in language consisted of block characters, such as the Chinese language, may also function as a character string. In addition, the term “article” as applicable in this invention is not limited to a collection of “character”. A collection consisted of or comprising characters, symbols and/or numbers are searchable “articles” in this invention. An array of strings of character, symbol and/or number may be a “character string” under the definition of this invention.

In some embodiments of this invention, the concept-character string look-up-table 10 further comprises weights of respective character strings. The weight of a character string represents the intensity of the character string in the calculation of the relative intensity value between an article and the concept represented by the search keyword corresponding to the character string. The value of the weights may be obtained from all kinds of applicable methods. For example, it is possible to use the mean frequency of existence (number of location in an article) of the character string in articles that are determined “closely relative” to a concept as basic value of the weight. As to how close an article is relatively to a concept, an expert in the field where the concept of interests belongs may be used to determined. The expert determines a limited number of articles one by one and articles labeled as “closely related”, “related” and “non-related” are collected and analyzed to obtain a group of useful character strings. Alternatively, it is also possible to allow a user to determine subjectively the relation between a limited number of articles to obtain character strings for personal use.

In addition, in some embodiments of this invention, the weight is not necessary a positive value. For example, character strings that exist in most articles may be given the weight of “0”, to avoid wrong unnecessary errors. When an article may be easily determined “non-relative” in case a character string exists in that article, the character string may be given a negative weight; Or, an article is labeled “non-related” (a relative intensity value of 0), upon the existence of the character string in that article is found.

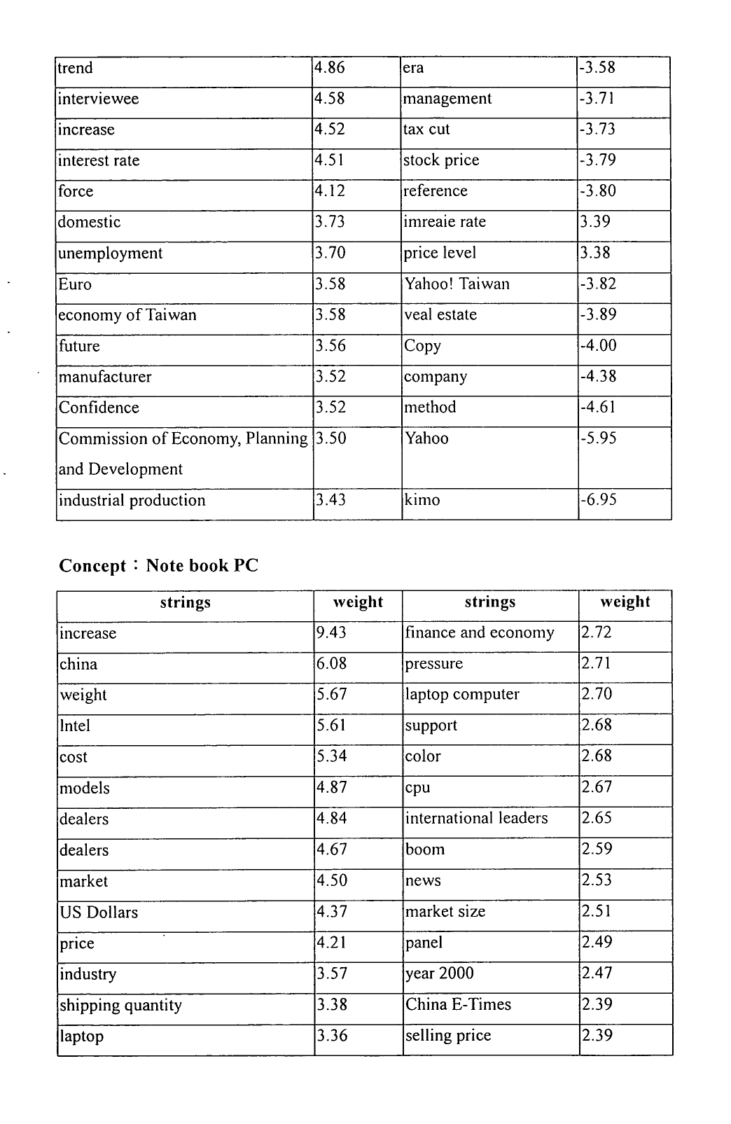

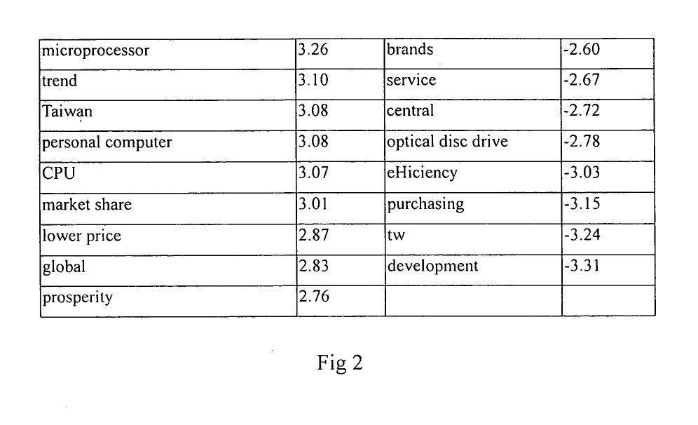

FIG. 2 is a table shows several popular search keywords and a number of their respectively corresponding character strings and their weights.

The article database 50 of this invention may be a memory device to store a large quantity of articles (as defined above), provided with the conceptual article collector. However, a remote memory device to store a large quantity of articles, or even the internet, may be an applicable article database of this invention. If a remote memory device or the internet is used, preferably addresses or other accessible connecting factors are provided in the conceptual article collector, such that the articles may be easily retrieved. In other words, the article database is not necessary a memory to store a quantity of articles; It may be an access means to access a large quantity of articles.

The article pre-search means 30 is one of the major features of this invention. Although it is not intended to limit the scope of this invention, the inventor found that character strings corresponding to popular search keywords belong to a cell of limited elements, although the keywords that users will use to search or collect articles can never be predicted. In addition, many character strings are labeled “relative” to different search keywords at the same time and are included in the concept-character string look-up-table 10. In other words, a particular character string may correspond to different “concepts” and labeled with varied weights. Thus, it is possible to use a limited number of character strings to conduct pre-search of articles in advance.

The article pre-search means 30 of this invention may search articles contained in or accessible by the article database 50 from time to time, based on the character strings contained in the concept-character string look-up-table 10. The results of such pre-searches are converted into representative codes, such as addresses where the articles are stored, and their respective relative intensity values, representing frequency of existence of a character string in the corresponding articles, are stored in the character string-article look-up-table. In conducting the pre-search, the whole text of an article is compared with the character strings one by one. Number of existence of a character string in the article is calculated and modified to be the relative intensity value.

In some embodiments of this invention, a character string-article look-up-table 20 containing character strings corresponding a number of popular concepts are prepared in advance. As a result, for popular concepts, a user needs not to conduct full searches to obtain desired articles, since representative codes of the desired articles are already stored in the character string-article look-up-table 20. In conducting the pre-search, useful factors include: number or frequency of existence of a character string in an article, addresses of a character string existing in an article etc. If a character string does not exist in an article, the relative intensity value of the character string in the article will be given as 0.

The function of the article search means 40 is to allow a user to input a search keyword or keywords and to pick up articles that are determined “closely related” to the concept represented by the input keyword(s). The search process of the article search means 40 will be described in the followings.

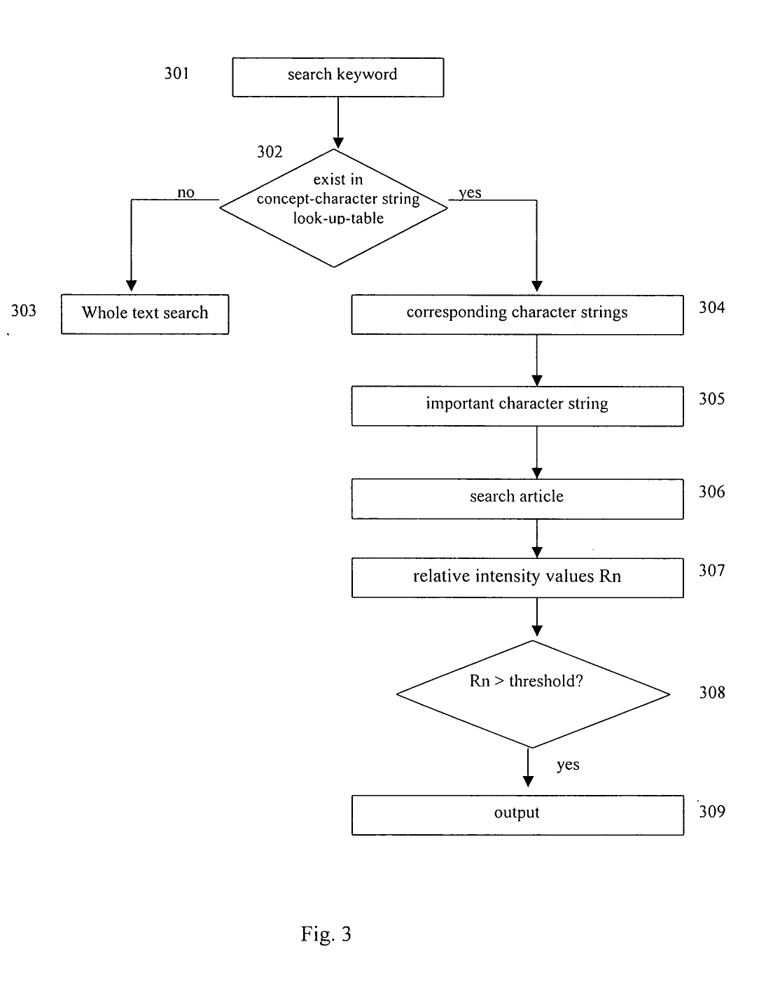

FIG. 3 illustrates the flowchart of search conducted by the article search means 40 of the present invention. As shown in this figure, at 301 the user inputs a search keyword. The article search means 40 allocates the keyword from the index column (concept column) of the concept-character string look-up-table 10 at 302. In general, the concept-character string look-up-table 10 does not necessarily contain identical keyword as its index. For example, when the input keyword is “coffee shops in Taipei”, it is possible that “coffee”, “shop” and “Taipei” are found in the index column of the concept-character string look-up-table 10. As such, necessary adjustments may be necessary, such that optimal search keywords may be selected. Of course, how an optimal search keyword may be selected is not the core technology of this invention and belongs to the known art. Detailed description thereof is thus omitted.

If the search keyword or a part of the search keyword does not exist in the concept column of the concept-character string look-up-table 10, the whole text search is then conducted at 303. Since the whole text search is a known art, detailed description thereof is thus omitted. If one or more search keywords are found in the concept-character string look-up-table 10, a collection of their corresponding character strings are found at 304. At 305, a certain number of character string is selected from the collection of character strings and is labeled as “important character string”. Important character strings include character strings with absolute weight values greater than a predetermined value. They may also include character strings with weight values of 0. The purpose of selecting important character strings is to conduct the search based on character strings that give greater influence in the calculation of the relative intensity values of searched articles, so to reduce number of character strings and articles that need to be processed, in order to save processing time. At 306, articles (representative codes of articles) in the character string-article look-up-table 20 that correspond to the important character strings and have a weight value other than 0 are allocated. The relative intensity values (Rn) of the allocated articles are calculated at 307 with the following formula:
Rn=ΣSiWi (1)
wherein Rn represents the relative intensity value of Document n in relation to the concept represented by the input search keyword, Si represents number of location of existence or frequency of existence of Character String i in Document n, Wi represents weight of Character String i in the concept-character string look-up-table, n, i are natural numbers, |Wi|<1.

At 308 Rn is compared with a threshold. At 309 articles which Rn is greater than the threshold are labeled. The search is thus completed.

In the above processing, if applicable concepts (keywords) are more than one, a Boolean operation maybe conducted in addition. Nevertheless, if the weight of a character string in the concept-character string look-up-table 10 is 0, it is possible to use a Boolean operation to make the Rn to be 0, such that the search process may be further simplified.

As the present invention has been shown and described with reference to preferred embodiments thereof, those skilled in the art will recognize that the above and other changes may be made therein without departing form the spirit and scope of the invention.

1. A conceptual article collector comprising:
a concept-character string look-up-table indexed by keywords for searching articles, each keyword corresponding to a plurality of character strings and their respective searching conditions;
a character string-article look-up-table indexed by character strings contained in said concept-character string look-up-table, each character string corresponding to a quantity of articles being processed;
an article pre-search means to from time to time search in a quantity of articles based on character strings in said concept-character string look-up-table and to store result of such search in said character string-article look-up-table;
an article search means to search in indexes in said concept-character string look-up-table according to keywords input by user to obtain corresponding character strings therein, to search corresponding articles of the searched character strings in said character string-article look-up-table, to calculate the relative intensity values of each searched article and the concept represented by said input keyword and to output result of such calculation; and
an article database to store a quantity of articles to be searched.

2. The conceptual article collector according to claim 1 wherein said concept-character string look-up-table comprises a plurality of keywords and their corresponding character strings and weights of respective character strings; wherein said weight of one character string represents influence in the calculation of the relation between an article containing said one character string and the keyword corresponding to said one character string and wherein a character string comprises a collection of characters, symbols and/or numbers.

3. The conceptual article collector according to claim 2 wherein said character string comprises a word in the Chinese language system.

4. The conceptual article collector according to claim 1 wherein said article database comprises a communication device connectable to a remote database.

5. The conceptual article collector according to claim 1 wherein said article pre-search means searches in said article database at predetermined intervals.

6. The conceptual article collector according to claim 1 wherein said article search means conducts whole text search in said article database if an input search keyword is not contained in the index of the concept-character string look-up-table.

7. The conceptual article collector according to claim 1 wherein said article search means calculates the relative intensity value Rn of an article (Document n) in relation to said concept represented by said input keyword according to the following formula:
Rn=ΣSiWi
wherein Rn represents the relative intensity value of Document n in relation to the concept represented by the input search keyword, Si represents number of location of existence or frequency of existence in Document n of Character String i, which is corresponding to the input search keyword in said concept-character string look-up-table, Wi represents weight of Character String i defined in the concept-character string look-up-table, n, i are natural numbers, |Wi|<1.

8. The conceptual article collector according to claim 1 wherein said article search means further compares the relative intensity value of a searched article with a threshold and labels articles with relative intensity value greater than said threshold.
